(19) United States
(12) Patent Application Publication
(10) Pub. No.: US 2026/0086582 A1
(43) Pub. Date: Mar. 26, 2026

(54) MASS FLOW CONTROLLER, AND METHOD OF CONTROLLING FLUID SUPPLY FLOW RATE BY USING THE SAME

(71) Applicant: Samsung Electronics Co., Ltd., Suwon-si (KR)

(72) Inventors: Seunghun KIM, Suwon-si (KR); Geongu JANG, Suwon-si (KR); Youngjoo KIM, Suwon-si (KR); Jiho UH, Suwon-si (KR)

(21) Appl. No.: 19/282,339

(22) Filed: Jul. 28, 2025

(30) Foreign Application Priority Data
Sep. 20, 2024 (KR) 10-2024-0127549
Dec. 10, 2024 (KR) 10-2024-0183133

(51) Int. Cl. G05D 7/06

(52) U.S. Cl. CPC G05D 7/0647

(57) ABSTRACT

A mass flow controller includes a first flow path, a second flow path, a bypass flow path, an internal valve in the bypass flow path, a pressure sensor, a flow rate sensor, and a control unit. The control unit is configured to calculate a pressure-flow rate correlation coefficient based on a difference between a pressure value at a first time and a pressure value at a second time, and based on the amount of leakage of fluid from the first time up to the second time. The control unit is configured to calculate a delay time based on the pressure-flow rate correlation coefficient and a difference between the pressure value at the first time and a pressure value at a third time, and the control unit is configured to delay opening of the internal valve for an amount of time corresponding to the delay time.

### CROSS-REFERENCE TO RELATED APPLICATIONS

This application is based on and claims priority under 35 U.S.C. § 119 to Korean Patent Application Nos. 10-2024-0127549, filed on Sep. 20, 2024, and 10-2024-0183133, filed on Dec. 10, 2024, in the Korean Intellectual Property Office, the disclosure of which are incorporated by reference herein in its entirety.

### TECHNICAL FIELD

The inventive concept relates to a mass flow controller and a method of controlling a fluid supply flow rate by using the same, and more particularly, to a mass flow controller and a method of controlling a fluid supply flow rate by using the same, which may improve the enhancement of a fluid supply flow rate.

### BACKGROUND

In a semiconductor manufacturing process, mass flow controllers (MFCs) are used for measuring and controlling a flow rate of a gas or other fluid supplied into a process chamber. To obtain smooth process results, MFCs control a flow rate of gas or other fluid so that the gas or other fluid is accurately supplied within a certain range.

### SUMMARY

The inventive concept provides a mass flow controller and a method of controlling fluid supply flow rate by using the same, which may improve the enhancement of a fluid supply flow rate and may thus improve the quality of a resultant material of a process based on a fluid supplied by the mass flow controller.

A mass flow controller according to an embodiment includes a first flow path connected to an inflow path configured to allow fluid to flow into the mass flow controller; a second flow path connected to an outflow path configured to allow the fluid to flow out of the mass flow controller; a bypass flow path connected to the first flow path and the second flow path; an internal valve in the bypass flow path; a pressure sensor configured to measure pressure of a first space comprising a portion of the bypass flow path and the first flow path; a flow rate sensor configured to measure a flow rate of fluid flowing through the bypass flow path; and a control unit configured to control the internal valve. The control unit is configured to calculate a pressure-flow rate correlation coefficient, based on: a difference between a first pressure value of the first space measured by the pressure sensor at a first time at which or after flow of the fluid stops and a second pressure value of the first space measured by the pressure sensor at a second time after the first time; and a first amount of leakage of fluid measured by the flow rate sensor from the first time up to the second time. The control unit is configured to calculate a delay time, based on the pressure-flow rate correlation coefficient and a difference between the first pressure value of the first space measured by the pressure sensor at the first time and a third pressure value measured by the pressure sensor at a third time after the second time, and the control unit is configured to delay opening of the internal valve for an amount of time corresponding to the delay time.

A method of controlling a fluid supply flow rate according to an embodiment includes stopping fluid flow from a mass flow controller to a process chamber at a first time; measuring an amount of leakage of fluid from a first space and a difference between a first pressure value of the first space at the first time and a second pressure value of the first space at a second time after the first time; calculating a pressure-flow rate correlation coefficient based on the difference between the first and second pressure values and the amount of leakage of fluid; restarting the fluid flow from the mass flow controller to the process chamber at a third time; measuring a difference between the first pressure value of the first space at the first time and a third pressure value of the first space at the third time, and calculating a delay time based on the difference between the first and third pressure values and on the pressure-flow rate correlation coefficient; and delaying opening of an internal valve of the mass flow controller, for the delay time from the third time

A method of controlling a fluid supply flow rate according to some embodiments includes closing a first valve and a second valve by a control device, and closing an internal valve by a control unit responsive to receiving an electrical signal from the control device, thereby stopping fluid flow from a mass flow controller to a process chamber at a first time; measuring a first amount of leakage of fluid from a first space and a difference between a first pressure value of the first space at the first time and a second pressure value of the first space at a second time after the first time; calculating, by the control unit, a pressure-flow rate correlation coefficient based on the difference between the first and second pressure values and on the first amount of leakage of fluid; opening the first valve and the second valve by the control device, thereby restarting the fluid flow from the mass flow controller to the process chamber at a third time; measuring, by the control unit, a difference between the first pressure value of the first space at the first time and a third pressure value of the first space at a the third time, and calculating a delay time based on the difference between the first and third pressure values and on the pressure-flow rate correlation coefficient; delaying, by the control unit, opening of the internal valve of the mass flow controller for the delay time from the third time; and after the restarting of the fluid flow, re-calculating, by the control unit, the pressure-flow rate correlation coefficient based on a second amount of leakage of fluid from the first space, and based on a difference between a fourth pressure value of the first space at a fourth time after stopping the fluid flow and a fifth pressure value of the first space at a fifth time after the fourth time.

### BRIEF DESCRIPTION OF THE DRAWINGS

Embodiments will be more clearly understood from the following detailed description taken in conjunction with the accompanying drawings in which:

FIG. 1 is a block diagram schematically illustrating a mass flow controller according to embodiments;

FIG. 2 is a flowchart for describing a method of controlling a fluid supply flow rate by using a mass flow controller, according to embodiments;

FIG. 3 is a flowchart for describing a method of controlling a fluid supply flow rate by using a mass flow controller, according to embodiments; and

FIG. 4 is a graph of fluid flow rate setting value (SET flow rate) versus time when a process based on a method of controlling a fluid supply flow rate according to embodiments is performed.

### DETAILED DESCRIPTION OF EMBODIMENTS

Hereinafter, embodiments will be described in detail with reference to the accompanying drawings. Like reference numerals refer to like elements in the drawings, and their repeated descriptions are omitted. As used herein, a “duration” or “interval” of time may refer to an amount of time between a first point or instant in time and a second point or instant in time, as measured in a unit of time, for example, seconds. The terms “first,” “second,” etc., may be used herein merely to distinguish one component, element, direction, etc. from another. The terms “comprises,” “comprising,” “includes” and/or “including,” when used herein, specify the presence of stated elements, but do not preclude the presence of additional elements.

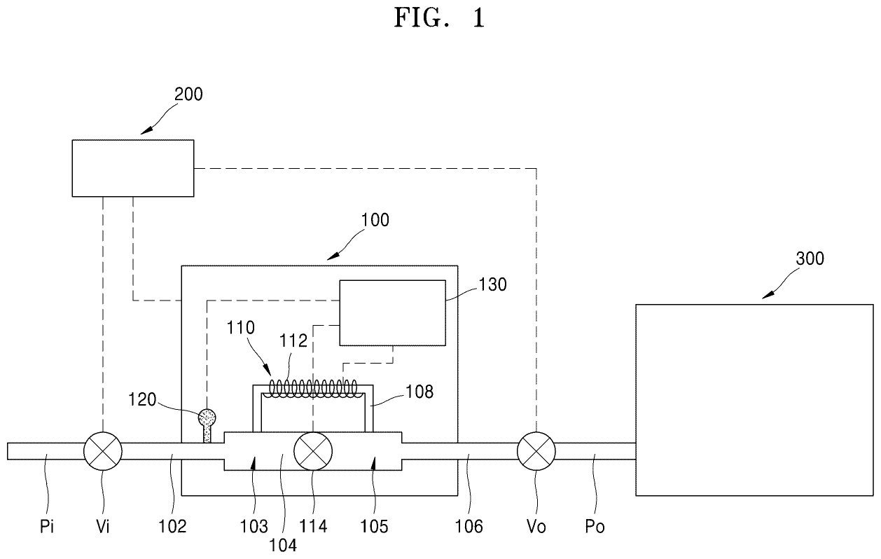

FIG. 1 is a block diagram schematically illustrating a mass flow controller 100 according to embodiments.

The mass flow controller 100 may include a first flow path 102, a bypass flow path 104, a second flow path 106, a flow rate sensor 110, a pressure sensor 120, and a control unit 130.

The mass flow controller 100 according to embodiments may be configured for a gas or other fluid. The mass flow controller 100 may be configured to measure a flow rate of a gas or other fluid supplied from an external device and control a flow rate supplied to a process chamber 300.

The first flow path 102 may connect with an inflow path Pi through which a fluid from the external device outside the mass flow controller 100 is supplied. The fluid supplied from the external device may be supplied to an inner portion of the mass flow controller 100 through the inflow path Pi and the first flow path 102. A first valve Vi may be disposed between the first flow path 102 and the inflow path Pi. The first valve Vi may be opened or closed based on control by the control unit 130. For example, the first valve Vi may include a first actuator (not shown) configured to be controlled by the control unit 130, and the first value Vi may be opened or closed based on an operation of the first actuator.

The bypass flow path 104 may connect with the first flow path 102 and the second flow path 106. The bypass flow path 104 may be configured to have a fluid resistance to the fluid supplied from the outside. Based on the fluid resistance applied by the bypass flow path 104, a fluid of a certain rate among fluids flowing through the first flow path 102 may flow into a sensor flow path 108 included in the flow rate sensor 110.

An internal valve 114 may be disposed in the bypass flow path 104. The internal valve 114 may be opened or closed based on control by the control unit 130. For example, the internal valve 114 may be a solenoid valve configured to be controlled by the control unit 130, and the internal valve 114 may be opened or closed by a control operation of the control unit 130.

The second flow path 106 may connect with an outflow flow path Po connected to the process chamber 300. A fluid supplied into the mass flow controller 100 may be supplied to the process chamber 300 through the second flow path 106 and the outflow flow path Po. A second valve Vo may be disposed between the second flow path 106 and the outflow path Po. The second valve Vo may be opened or closed based on control by the control unit 130. For example, the second valve Vo may include a second actuator (not shown) configured to be controlled by the control unit 130, and the second value Vo may be opened or closed based on an operation of the second actuator.

In embodiments, each of the first valve Vi and the second valve Vo may be a shut-off valve. In embodiments, the internal valve 114 may be a solenoid valve or a piezoelectric valve.

The flow rate sensor 110 may be configured to measure a flow rate of a fluid flowing into the mass flow controller 100. The flow rate sensor 110 may include the sensor flow path 108 and a sensor wire 112 surrounding the sensor flow path 108. For example, as the sensor wire 112 generates heat, the heat generated from the sensor wire 112 may be transferred to a fluid flowing through the sensor flow path 108, and thus, a temperature of the fluid may increase. At this time, a fluid flowing through an upper flow portion of the sensor flow path 108 may be heated in a state where a temperature thereof has increased by a relatively lesser amount, and a fluid flowing through a lower flow portion of the sensor flow path 108 may be heated in a state where a temperature thereof has increased by a relatively greater amount. Therefore, a temperature of the sensor wire 112 disposed in the upper flow portion may be lower than that of the sensor wire 112 disposed in the lower flow portion, and based on a temperature difference therebetween, an electrical resistance value of the sensor wire 112 may vary. Based on a variation difference of the electrical resistance value, a flow rate of a fluid flowing in the sensor flow path 108 may be detected by using a bridge circuit (not shown) included in the flow rate sensor 110.

Also, a flow rate of a fluid flowing to the second flow path 106 through the first flow path 102 may be detected based on the detected flow rate of the fluid flowing in the sensor flow path 108. The flow rate sensor 110 may be connected to the control unit 130 by wires or wirelessly and may transfer or receive an electrical signal, corresponding to a measured flow rate of a fluid, to or from the control unit 130. The measured flow rate of the fluid may be transferred to the control unit 130.

The pressure sensor 120 may be configured to measure a pressure of a first space 103 configured with a portion of each of the first flow path 102 and the bypass flow path 104. The pressure sensor 120 may measure the pressure of the first space 103 and may transfer or transmit an electrical signal indicating the measured pressure to the control unit 130. The pressure sensor 120 may be connected to the control unit 130 by wires or wirelessly and may transfer or receive an electrical signal, corresponding to a measured pressure value, to or from the control unit 130. The measured pressure value may thereby be provided to the control unit 130.

The control unit 130 may be configured to calculate a pressure-flow rate correlation coefficient, based on the flow rate value of the fluid transferred from the flow rate sensor 110 and the pressure value transferred from the pressure sensor 120, and calculate a delay time, based on the pressure-flow rate correlation coefficient. A “delay time” as described herein may refer to an interval or duration of time, rather than an instant in time. The control unit 130, for example, may be configured to transfer or receive an electrical signal to or from the flow rate sensor 110 and the pressure sensor 120, and thus, may respectively receive a value of a fluid flow rate and a pressure value as indicated by respective electrical signals from the flow rate sensor 110 and the pressure sensor 120. Also, the control unit 130 may be configured to control an operation of the internal valve 114. The control unit 130, for example, may be configured to transfer or receive an electrical signal to or from the internal valve 114, and thus, may control an opening/closing operation of the internal valve 114. The control unit 130, for example, may control an operation of the internal valve 114 so that an opening operation of the internal valve 114 is delayed by the delay time more than or after an opening operation of each of the first valve Vi and the second valve Vo by a control device 200 described below, based on the calculated delay time. That is, the control unit 130 may delay the opening of the internal valve past the moment at which the first valve Vi and the second valve Vo are opened, by a duration corresponding to the value of the calculated delay time.

The control device 200 may be configured to transfer or receive an electrical signal to or from the mass flow controller 100, the first valve Vi, and the second valve Vo. For example, the control device 200 may receive the value of the fluid flow rate, the pressure value, and the delay time, measured by the flow rate sensor 110 and the pressure sensor 120, from the mass flow controller 100, and may transfer an electrical signal to the control unit 130 to perform an opening operation of the internal valve 114. For example, the control device 200 may be configured to control an opening/closing operation of each of the first valve Vi and the second valve Vo.

Each of the control unit 130 and the control device 200 may be implemented with hardware, firmware, software, or an arbitrary combination thereof. For example, each of the control unit 130 and the control device 200 may be a workstation computer, a desktop computer, a laptop computer, or a table computer. For example, each of the control unit 130 and the control device 200 may include a non-transitory memory device, such as read only memory (ROM) or random access memory (RAM), or a processor (for example, a central processing unit (CPU) or a graphics processing unit (GPU)) configured to perform a certain arithmetic operation and a certain algorithm. Also, each of the control unit 130 and the control device 200 may include a receiver and a transmitter for respectively receiving and transmitting an electrical signal.

A fluid supplied to the mass flow controller 100 may be supplied from the mass flow controller 100 to the process chamber 300. A semiconductor process using the fluid may be performed in the process chamber 300. The semiconductor process may include, for example, various semiconductor processes such as an exposure process, a development process, and a cleaning process, but the kind of semiconductor process is not limited thereto.

The mass flow controller 100 according to embodiments may include the control unit 130, and the control unit 130 may receive the pressure value measured by the pressure sensor 120 and the value of the fluid flow rate measured by the flow rate sensor 110 and may calculate a pressure-flow rate correlation coefficient, based on the received pressure value and the received value of the fluid flow rate. Also, the control unit 130 may calculate a delay time, based on the calculated pressure-flow rate correlation coefficient, and may delay an opening time of the internal valve 114 for or by the delay time, and thus, may prevent an excessive supply of a fluid due to or caused by the amount of leakage of fluid and may improve or enhance fluid supply. Therefore, supply of a fluid to the process chamber 300 may be improved, and thus, the quality of a semiconductor process may be improved.

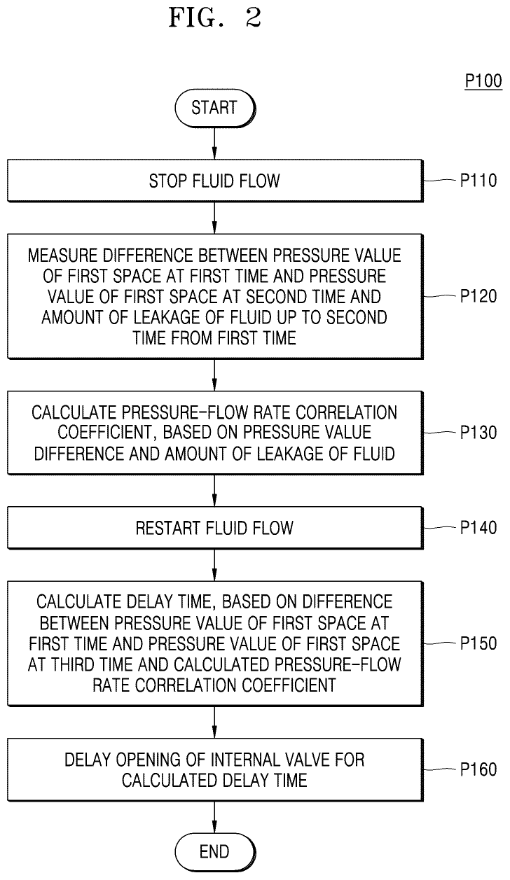

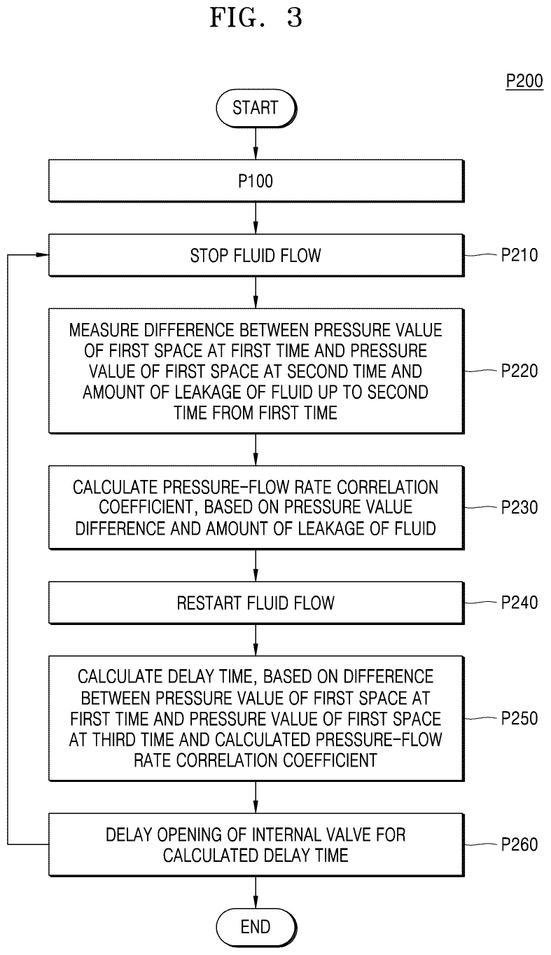

Hereinafter, a method of controlling a fluid supply flow rate by using the mass flow controller 100 will be described in greater detail with reference to FIGS. 2 and 3.

FIG. 2 is a flowchart for describing a method P100 of controlling a fluid supply flow rate by using the mass flow controller 100, according to embodiments.

Referring to FIGS. 1 and 2, a flow of a fluid may be stopped by the control device 200 in process P110. That is, the first valve Vi and the second valve Vo may be closed by the control device 200, and the internal valve 114 may be closed by the control unit 130 which has received an electrical signal from the control device 200. A stop state of fluid flow may denote that a setting value of a fluid flow rate supplied to the process chamber 300 through the inflow path Pi is 0.

In embodiments, each of the first valve Vi and the second valve Vo may be a shut-off valve. In embodiments, the internal valve 114 may be a solenoid valve or a piezoelectric valve.

The shut-off valve may have a strong closing force, and thus, in a case where each of the first valve Vi and the second valve Vo is closed, leakage of a fluid from each of the first valve Vi and the second valve Vo may not occur. On the other hand, the solenoid valve or the piezoelectric valve may have a relatively weak closing force, and thus, in a case where the internal valve 114 is closed, leakage of a fluid from the internal valve 114 may occur. A leaked fluid may be disposed between the internal valve 114 and the second valve Vo, namely, in the second space 105.

Subsequently, in process P120, a pressure variation value and a value of a fluid flow rate of the first space 103 may be measured up to an arbitrary or certain time after a time at which fluid flow is stopped by the control device 200. The time at which the fluid flow is stopped by the control device 200 may be referred to herein as a first time or initial time t₀. The arbitrary or certain time after the first time t₀ may be referred to herein as a second time t₁.

For example, after an arbitrary or certain second time t₁ (for example, 10 seconds) elapses from the first time t₀, a difference between a pressure value of the first space 103 measured at the first time t₀ and a pressure value of the first space 103 measured at the second time t₁ may be measured by the pressure sensor 120.

Also, for example, an integral value of a fluid flow rate may be measured by the flow rate sensor 110 up to the second time t₁ from the first time t₀, e.g., measured over an interval or duration of time between the first time t₀ and the second time t₁. In this case, because a leakage of a fluid does not occur in the first valve Vi and the second valve Vo, the integral value of the fluid flow rate up to the second time t₁ from the first time t₀ may denote the amount of leakage of fluid leaked from the internal valve 114.

The measured difference between the pressure values of the first space 103 (e.g., at time to and at time t₁) and the integral value of the fluid flow rate may be transferred to the control unit 130.

Subsequently, a pressure-flow rate correlation coefficient may be calculated based on the measured difference between the pressure values of the first space 103 (e.g., at time t₀ and at time t₁) and the integral value of the fluid flow rate in process P130.

The pressure-flow rate correlation coefficient may be calculated as expressed in the following Equation 1.

$$Ratio = \frac{Leak}{Δ P} \qquad [ Equation 1 ]$$

In Equation 1, Ratio may denote a pressure-flow rate correlation coefficient, Leak may denote an integral value of a fluid flow rate, and ΔP may denote a difference between the pressure value of the first space 103 at the second time t₁ and the pressure value of the first space 103 at the first time t₀.

Subsequently, fluid flow may be restarted by the control device 200 in process P140. As the fluid flow is restarted by the control device 200, the first valve Vi and the second valve Vo may be opened. A restart state of fluid flow may denote that a setting value of a fluid flow rate supplied to the process chamber 300 through the inflow path Pi is an arbitrary positive value instead of 0, that is, a positive non-zero value.

Subsequently, a pressure value of the first space 103 at a third time t₂ at which fluid flow is restarted by the control device 200 may be measured and may be transferred to the control unit 130. Subsequently, a difference between the pressure value of the first space 103 at the first time to and the pressure value of the first space 103 at the third time t₂ at which the fluid flow is restarted by the control device 200 may be calculated by the control unit 130. Subsequently, in process P150, the control unit 130 may calculate a delay time, based on the difference between the pressure values (at time t₀ and at time t₂) and the Ratio value.

For example, a pressure value of the first space 103 at the third time t₂ (the time at which fluid flow is restarted by the control device 200) may be measured by the pressure sensor 120, and a difference between the pressure value of the first space 103 measured at the first time to and the pressure value of the first space 103 measured at the third time t₂ may be calculated by the pressure sensor 120.

Subsequently, a Leak value (e.g., indicating an amount of leakage) up to the third time t₂ from the first time t₀ may be calculated by multiplying a difference value between the pressure value of the first space 103 at the first time t₀ and the pressure value of the first space 103 at the third time t₂ by the Ratio value (i.e., the pressure-flow rate correlation coefficient) which is calculated in operation P130.

Subsequently, the delay time may be calculated based on the Leak value. The delay time may be calculated as expressed in the following Equation 2.

$$Delay time [ min ] = \frac{Sampling Rate [ Hz ]}{} \div SET \qquad [ Equation 2 ]$$

In Equation 2, [symbol] may denote the calculated Leak value up to the third time t₂, SET may denote a setting value of a fluid flow rate which is set in operation P140, and Sampling Rate may denote a coefficient for unit conversion.

For example, when a SET value is about 500 ccm, and a Leak value is about 3.65 cc, the delay time may be calculated to be about 0.0073 min, that is, about 0.438 sec.

Herein, for convenience of description, process P140 and process P150 have been described as separate processes, but embodiments are not limited thereto, and process P140 and process P150 may be substantially simultaneously performed in some embodiments.

Subsequently, in process P160, an opening operation of the internal valve 114 may be delayed for the delay time calculated by the control unit 130. In other words, after the first valve Vi and the second valve Vo are opened and the delay time elapses, the internal valve 114 may be opened. That is, once the delay time has elapsed from the third time t₂, the internal valve 114 may be opened. Because the delay time is calculated based on the amount of leakage of fluid, a fluid having a value or amount corresponding to the amount of leakage of fluid may be less supplied (or may not be supplied) to the process chamber 300, due to the delayed opening of the internal valve 114. As a result, an excessive supply of a fluid (which may otherwise be caused by leakage of fluid of when the delayed opening of the internal valve 114 does not occur) may be prevented, and enhancement of fluid supply to the process chamber 300 may be improved.

FIG. 3 is a flowchart for describing a method P200 of controlling a fluid supply flow rate by using the mass flow controller 100, according to embodiments.

Referring to FIGS. 1 and 3, process P100 described above with reference to FIGS. 1 and 2 may be performed.

Subsequently, in process P210, fluid flow may be stopped by the control device 200. Process P210 may be substantially the same as process P110 described above with reference to FIGS. 1 and 2. A time at which the fluid flow is stopped at process P210 may be a first time t₀′.

Subsequently, in process P220, a pressure variation value and a value of a fluid flow rate of the first space 103 may be measured up to an arbitrary amount of time from the first time t0′. Process P220 may be substantially the same as process P120 described above with reference to FIGS. 1 and 2.

Subsequently, a pressure-flow rate correlation coefficient may be updated (i.e., re-calculated) based on the measured difference between the pressure values of the first space 103 and the integral value of the fluid flow rate in process P230.

The pressure-flow rate correlation coefficient may be calculated as expressed in the following Equation 3.

$${Ratio}_{n} = \frac{{Leak}_{n}}{Δ {P}_{n}} \qquad [ Equation 3 ]$$

In Equation 3, Ratioₙ may denote an n^{th}-calculated pressure-flow rate correlation coefficient, Ratioₙ₋₁ may denote an n^{th}-1-calculated (i.e., a previously-calculated) pressure-flow rate correlation coefficient, Leakₙ may denote an n^{th}-measured integral value of a fluid flow rate, namely, may denote the amount of leakage of fluid, and ΔPₙ may denote a difference between an n^{th}-measured pressure value of the first space 103 measured at the first time t₀′ time and an n^{th}-measured pressure value of the first space 103 at a second time t₁′.

For example, when process P100 is a first process, and processes subsequent to process P210 performed after process P100 are a second process, a Ratio value calculated in process P100 may be a first-calculated Ratio value and may correspond to Ratio₁, a Ratio value calculated in process P230 may be a second-calculated Ratio value and may correspond to Ratio₂, a Leak value measured in process P220 may correspond to a second-measured Leak₂ value, and a ΔP value measured in process P220 may correspond to a second-measured ΔP₂ value.

That is, Ratioₙ may denote a movement or moving average value of Ratio values calculated based on the measured pressure difference value and the measured value of the fluid flow rate. In other words, Ratioₙ may be a value which is updated or re-calculated as the processes are repeated.

Subsequently, fluid flow may be restarted by the control device 200 in process P240. Process P240 may be substantially the same as process P140 described above with reference to FIGS. 1 and 2.

Subsequently, a pressure value of the first space 103 at a third time t₂′ at which fluid flow is restarted by the control device 200 may be measured and may be transferred to the control unit 130. Subsequently, a difference between the pressure value of the first space 103 at the first time t₀′ and the pressure value of the first space 103 at the third time t₂′ at which the fluid flow is restarted by the control device 200 may be calculated by the control unit 130. Subsequently, the control unit 130 may calculate a Leak value up to the third time t₂′ from the first time t₀′, based on the Ratioₙ value and the difference between the pressure values. Subsequently, in process P250, a delay time may be calculated as expressed in the following Equation 4, based on the Leak value and Ratioₙ up to the third time t₂′ from the first time t₀′.

$$Delay time [ min ] = \frac{60 \cdot Sampling Rate [ Hz ]}{} \div {SET}_{n + 1} \qquad [ Equation 4 ]$$

In Equation 4, [symbol] may denote a Leak value calculated based on the Ratioₙ value and the difference between the pressure values, SETₙ₊₁ may denote a setting value of a fluid flow rate which is set in process P240, and Sampling Rate may denote a coefficient for unit conversion.

Subsequently, in process P260, an opening operation of the internal valve 114 may be delayed for the delay time calculated by the control unit 130. Because the delay time is calculated based on the Ratioₙ value obtained by performing the above-described processes a plurality of times, excessive supply of a fluid to the process chamber 300 caused by the amount of leakage of fluid may be more effectively prevented, and thus, enhancement of fluid supply may be more effectively improved.

Subsequently, after process P260 is performed, processes P210, P220, P230, P240, P250, and P260 may be repeatedly performed from process P210.

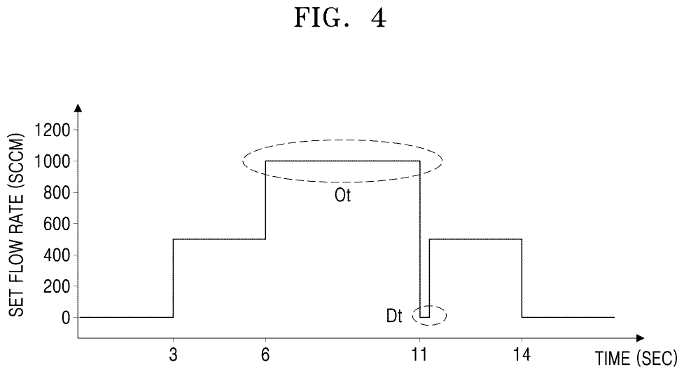

FIG. 4 is a fluid flow rate setting value (SET flow rate)—time graph when a process based on a method of controlling a fluid supply flow rate according to embodiments is performed. All numerical values shown in FIG. 4 are by way of example (e.g., based on simulated or experimental results); and it will be understood that numerical values in embodiments may differ.

First, before a process based on the graph of FIG. 4, process P110 of stopping fluid flow described above with reference to FIGS. 1 and 2 may be performed, and then, an integral value of a fluid flow rate and a pressure difference value may be measured up to a time at which about 10 sec elapses from a stop time of fluid flow in process P120, a pressure-flow rate correlation coefficient may be calculated based on the measured integral value of the fluid flow rate and the measured pressure difference value in process P130, and subsequently, fluid flow may be restarted for about 5 sec. A movement or moving average pressure-flow rate correlation coefficient of about 0.142 was obtained by repeatedly performing the process described above.

Subsequently, a pressure difference value up to the time at which about 10 sec elapses from the stop time of fluid flow was measured to be about 2.6 psi, and a fluid leakage value of about 0.37 cc was obtained by multiplying 2.6 psi by 0.142 to calculate the fluid leakage value. That is, when the internal valve 114 is closed for about 10 sec, it was determined that a fluid of about 0.37 cc is leaked.

Moreover, in order to simulate a case where the distortion of a supply flow rate is the maximum (i.e., a state where leakage of fluid is accumulated), a state where a pressure of the first space 103 is equal to that of the second space 105 with the internal valve 114 being closed may be considered. That is, a state where the internal valve 114 is closed for a relatively long duration of time, as illustrated in FIG. 4, a fluid has flowed from the first space 103 to the second space 105 by opening the internal valve 114 for about 5 sec (Ot) in a 100% open state in a state where the first valve Vi and the second valve Vo are closed, so that a pressure of the first space 103 is equal to that of the second space 105, may be simulated. In such a process, a difference between a pressure value of the first space 103 at a start time of about 5 sec and a pressure value of the first space 103 at an end time has been measured to be about 25.6 psi. Subsequently, about 3.65 cc, which is a leakage value of fluid in a state where the distortion of a supply flow rate is the maximum, has been obtained by multiplying the measured pressure value difference by the movement or moving average pressure-flow rate correlation coefficient value of about 0.142, which was obtained in the process described above. That is, when a case where the distortion of a supply flow rate is the maximum in a state where the internal valve 114 is closed for a relatively long duration of time (i.e., a state where the leakage of fluid is accumulated), it was determined that a fluid of about 3.65 cc is leaked.

A fluid leakage value when fluid flow stops for about 10 sec was measured to be 0.37 cc. This value was subtracted from 3.65 cc, which is a fluid leakage value when the distortion of a supply flow rate is the maximum, and a delay time was calculated with respect to a case where a fluid flow rate setting value is 500 CCM. As a result, a delay time value of about 0.39 sec was calculated.

Subsequently, an MFM flow rate (according to a process of record, POR) when the internal valve 114 is opened without a delay time after fluid flow stops for about 10 sec and a delay time, an average MFM flow rate for 3 sec in a case or an embodiment where the internal valve 114 is opened with a delay time Dt of about 0.39 sec after a case where the distortion of a supply flow rate is the maximum is performed through the process described above, and an average MFM flow rate for 3 sec in a case (a comparative example) where the internal valve 114 is opened without a delay time after a case where the distortion of a supply flow rate is the maximum is performed have been measured, and thus, an MFM flow rate-time result value has been obtained as shown in the following Table 1.

TABLE 1

| | average MFM flow rate |
|---|---|
| POR | 426.7 SCCM |
| embodiment | 423.4 SCCM |
| comparative example | 492.3 SCCM |

Referring to Table 1, it has been confirmed or determined that an embodiment where the internal valve 114 is opened after a calculated delay time elapses has an average MFM flow rate value almost similar to the POR, when compared to the POR, but the comparative example where the internal valve 114 is opened immediately without a delay time has an excessive average MFM flow rate value compared to the POR. That is, referring to FIG. 4 and Table 1, when a fluid is supplied by the method of controlling a fluid supply flow rate according to embodiments, excessive supply of a fluid may be prevented, and a fluid flow rate almost similar to a predetermined value (for example, the POR in Table 1) may be maintained, and thus, it may be seen that enhancement of a fluid supply flow rate is improved.

Hereinabove, embodiments have been described in the drawings and the specification by way of example. Embodiments have been described by using the terms described herein, but this has been merely used for describing the inventive concept and has not been used for limiting a meaning or limiting the scope of the inventive concept defined in the following claims. Therefore, it may be understood by those of ordinary skill in the art that various modifications and other equivalent embodiments may be implemented from the inventive concept. Accordingly, the scope of the inventive concept may be defined based on the scope of the following claims.

While the inventive concept has been particularly shown and described with reference to embodiments thereof, it will be understood that various changes in form and details may be made therein without departing from the scope of the following claims.

What is claimed is:

1. A mass flow controller comprising:
a first flow path connected to an inflow path configured to allow fluid to flow into the mass flow controller;
a second flow path connected to an outflow path configured to allow the fluid to flow out of the mass flow controller;
a bypass flow path connected to the first flow path and the second flow path;
an internal valve in the bypass flow path;
a pressure sensor configured to measure pressure of a first space comprising a portion of the bypass flow path and the first flow path;
a flow rate sensor configured to measure a flow rate of fluid flowing through the bypass flow path; and
a control unit configured to control the internal valve,
wherein the control unit is configured to calculate a pressure-flow rate correlation coefficient, based on: a difference between a first pressure value of the first space measured by the pressure sensor at a first time at which or after flow of the fluid stops and a second pressure value of the first space measured by the pressure sensor at a second time after the first time; and a first amount of leakage of fluid measured by the flow rate sensor from the first time up to the second time,
wherein the control unit is configured to calculate a delay time, based on the pressure-flow rate correlation coefficient and a difference between the first pressure value of the first space measured by the pressure sensor at the first time and a third pressure value measured by the pressure sensor at a third time after the second time, and
wherein the control unit is configured to delay opening of the internal valve for an amount of time corresponding to the delay time.

2. The mass flow controller of claim 1, wherein the control unit is configured to calculate the pressure-flow rate correlation coefficient by dividing the first amount of leakage of fluid from the first time up to the second time by the difference between the first pressure value of the first space at the first time and the second pressure value of the first space at the second time.

3. The mass flow controller of claim 1, wherein the control unit is configured to calculate a second amount of leakage of fluid from the first time up to the third time by multiplying the pressure-flow rate correlation coefficient by the difference between the first pressure value of the first space measured by the pressure sensor at the first time and the third pressure value measured by the pressure sensor at the third time, and
the control unit is configured to calculate the delay time by dividing the second amount of leakage of fluid from the first time up to the third time by a value of a set fluid flow rate.

4. The mass flow controller of claim 1, wherein the internal valve is a solenoid valve or a piezoelectric valve.

5. The mass flow controller of claim 1, further comprising:
a first valve between the inflow path and the first flow path, and a second valve between the outflow path and the second flow path; and
a control device configured to control the first valve and the second valve.

6. The mass flow controller of claim 5, wherein each of the first valve and the second valve is a shut-off valve.

7. The mass flow controller of claim 5, wherein, at the third time, the control device is configured to restart fluid flow and open each of the first valve and the second valve, and
wherein control unit is configured to open the internal valve after the delay time has elapsed from the third time.

8. The mass flow controller of claim 7, wherein, after restart of the fluid flow, the control unit is configured to re-calculate the pressure-flow rate correlation coefficient based on a second amount of leakage of fluid from the first space measured by the flow rate sensor, and based on a difference between a fourth pressure value of the first space measured by the pressure sensor at a fourth time at which the flow of the fluid stops and a fifth pressure value of the first space measured by the pressure sensor at a fifth time after the fourth time.

9. A method of controlling a fluid supply flow rate, the method comprising:
stopping fluid flow from a mass flow controller to a process chamber at a first time;
measuring an amount of leakage of fluid from a first space and a difference between a first pressure value of the first space at the first time and a second pressure value of the first space at a second time after the first time;
calculating a pressure-flow rate correlation coefficient based on the difference between the first and second pressure values and the amount of leakage of fluid;
restarting the fluid flow from the mass flow controller to the process chamber at a third time;
measuring a difference between the first pressure value of the first space at the first time and a third pressure value of the first space at the third time, and calculating a delay time based on the difference between the first and third pressure values and on the pressure-flow rate correlation coefficient; and
delaying opening of an internal valve of the mass flow controller, for the delay time from the third time.

10. The method of claim 9, wherein the pressure-flow rate correlation coefficient is calculated by dividing the amount of leakage of fluid from the first time up to the second time by a difference between the first pressure value of the first space at the first time and the second pressure value of the first space at the second time.

11. The method of claim 9, wherein a second amount of leakage of fluid from the first time up to the third time is calculated by multiplying the pressure-flow rate correlation coefficient by the difference between the first pressure value of the first space at the first time and the third pressure value at the third time, and
the delay time is calculated by dividing, by a fluid flow rate setting value, the second amount of leakage of fluid from the first time up to the third time.

12. The method of claim 9, wherein the internal valve is in a bypass flow path that connects a first flow path and a second flow path of the mass flow controller, and wherein a first valve coupled to the first flow path and a second valve coupled to the second flow path are opened at the third time.

13. The method of claim 9, wherein the internal valve is opened after the delay time has elapsed from the third time.

14. The method of claim 9, further comprising, after the restarting of the fluid flow:
re-calculating the pressure-flow rate correlation coefficient based on a second amount of leakage of fluid from the first space, and based on a difference between a fourth pressure value of the first space at a fourth time after stopping the fluid flow and a fifth pressure value of the first space at a fifth time after the fourth time.

15. The method of claim 12, wherein each of the first valve and the second valve is a shut-off valve, and the internal valve is a solenoid valve or a piezoelectric valve.

16. The method of claim 15, wherein the internal valve is configured to operate based on control by a control unit of the mass flow controller, and each of the first valve and the second valve is configured to operate based on control by a control device that is electrically connected to the mass flow controller.

17. The method of claim 16, wherein the stopping of the fluid flow and the restarting of the fluid flow are controlled by operation of the first and second valves by the control device.

18. A method of controlling a fluid supply flow rate, the method comprising:
closing a first valve and a second valve by a control device, and closing an internal valve by a control unit responsive to receiving an electrical signal from the control device, thereby stopping fluid flow from a mass flow controller to a process chamber at a first time;
measuring a first amount of leakage of fluid from a first space and a difference between a first pressure value of the first space at the first time and a second pressure value of the first space at a second time after the first time;
calculating, by the control unit, a pressure-flow rate correlation coefficient based on the difference between the first and second pressure values and on the first amount of leakage of fluid;
opening the first valve and the second valve by the control device, thereby restarting the fluid flow from the mass flow controller to the process chamber at a third time;
measuring, by the control unit, a difference between the first pressure value of the first space at the first time and a third pressure value of the first space at a the third time, and calculating a delay time based on the difference between the first and third pressure values and on the pressure-flow rate correlation coefficient;
delaying, by the control unit, opening of the internal valve of the mass flow controller for the delay time from the third time; and
after the restarting of the fluid flow, re-calculating, by the control unit, the pressure-flow rate correlation coefficient based on a second amount of leakage of fluid from the first space, and based on a difference between a fourth pressure value of the first space at a fourth time after stopping the fluid flow and a fifth pressure value of the first space at a fifth time after the fourth time.

19. The method of claim 18, wherein the pressure-flow rate correlation coefficient is calculated by dividing the first amount of leakage of fluid from the first time up to the second time by the difference between the first pressure value of the first space at the first time and the second pressure value of the first space at the second time.

20. The method of claim 18, wherein a third amount of leakage of fluid from the first time up to the third time is calculated by multiplying the pressure-flow rate correlation coefficient by the difference between the first pressure value of the first space at the first time and the third pressure value at the third time, and
the delay time is calculated by dividing, by a fluid flow rate setting value, the third amount of leakage of fluid from the first time up to the third time.
